(19) United States
(12) Patent Application Publication
(10) Pub. No.: US 2016/0322163 A1
(43) Pub. Date: Nov. 3, 2016

(54) TERMINAL ELECTRODE OF ELECTRONIC COMPONENT

(71) Applicant: E I DU PONT DE NEMOURS AND COMPANY, Wilmington, DE (US)

(72) Inventor: TOSHIAKI OGIWARA, TOCHIGI-KEN (JP)

(21) Appl. No.: 15/133,307

(22) Filed: Apr. 20, 2016

Related U.S. Application Data
(60) Provisional application No. 62/153,653, filed on Apr. 28, 2015.

(51) Int. Cl. H01G 4/008; H01G 4/228; H01C 17/28

(52) U.S. Cl. CPC H01G 4/008; H01C 17/28; H01G 4/228

(57) ABSTRACT

A method of manufacturing an electronic component comprising the steps of: preparing a bare chip; applying a conductive paste on the bare chip, wherein the conductive paste comprises, (i) 40 to 72 weight percent (wt. %) of a flaky silver powder having particle diameter (D50) of 6 to 30 μm, (ii) 3 to 30 wt. % of a copper oxide powder, and (iii) 20 to 50 wt. % of an organic vehicle, wherein the wt. % is based on the weight of the conductive paste; and heating the applied conductive paste at 250 to 400° C.

### FIELD OF INVENTION

The present invention relates to an electronic component, more specifically to a terminal electrode.

### TECHNICAL BACKGROUND OF THE INVENTION

An electronic component typically contains at least one terminal electrode that is connected to a circuit by solder. The terminal electrode is often made from a conductive pate containing a metal powder and an organic vehicle. Organic components contained in the terminal electrode could degrade by soldering heat of, for example, 270° C. The degraded organic components could damage the solder when it discharges to the atmosphere through the solder.

WO2010074119 discloses a multilayer ceramic electronic component having external electrodes. The external electrode is formed from the conductive paste containing (A) metal particles having an average particle diameter of 0.2-30 μm and a melting point of not less than 700° C., (B) metal particles having an average particle diameter of 0.2-18 μm and a melting point of 200° C. or more but less than 700° C., (C) a paste which is obtained by mixing one or more copper-containing compounds selected from a group consisting of copper nitrate, copper cyanide, copper octanoate, copper formate, copper acetate, copper oxalate, copper benzoate and copper acetylacetonate, an amino compound, and if necessary, an organic solvent, and (D) a thermosetting resin.

### BRIEF SUMMARY OF THE INVENTION

An objective is to provide an electronic component comprising a terminal electrode that would discharge less organic compounds during soldering.

An aspect of the invention relates to a method of manufacturing an electronic component comprising the steps of: preparing a bare chip; applying a conductive paste on the bare chip, wherein the conductive paste comprises: (i) 40 to 72 weight percent (wt. %) of a flaky silver powder having particle diameter (D50) of 6 to 30 μm, (ii) 3 to 30 wt. % of a copper oxide powder, and (iii) 20 to 50 wt. % of an organic vehicle, wherein the wt. % is based on the weight of the conductive paste; and heating the applied conductive paste at 250 to 400° C.

Another aspect of the invention relates to a conductive paste for forming a terminal electrode of an electronic component comprising: (i) 40 to 72 weight percent (wt. %) of a flaky silver powder having particle diameter (D50) of 6 to 30 μm, (ii) 3 to 30 wt. % of a copper oxide powder, and (iii) 20 to 50 wt. % of an organic vehicle, wherein the wt. % is based on the weight of the conductive paste.

An electronic component that would cause less damage to the solder can be provided by the present invention.

### BRIEF DESCRIPTION OF THE DRAWINGS

FIG. 1 is a schematic cross-sectional drawing of a capacitor as an electronic component soldered to a circuit.

FIG. 2 is a schematic cross-sectional drawing of a resistor as an electronic component soldered to a circuit.

### DETAILED DESCRIPTION OF THE INVENTION

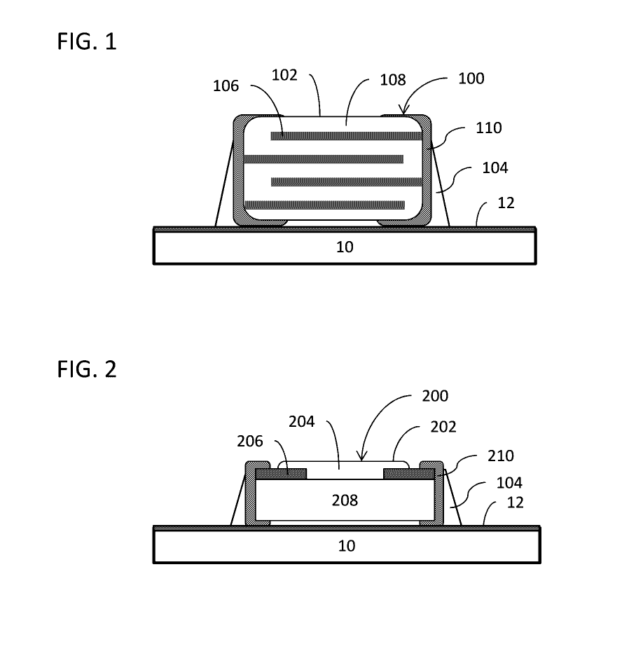

A method of manufacturing an electronic component comprises the steps of preparing a bare chip; applying a conductive paste on the bare chip; heating the applied conductive paste at 250 to 400° C. The following explains the method along with FIG. 1.

The bare chip is prepared. The bare chip comprises at least one insulating ceramic layer and at least one internal electrode 106 on the ceramic layer in an embodiment. The electronic component is a capacitor 100 in an embodiment. The bare chip 102 of a capacitor 100 comprises insulating ceramic layers 108 and internal electrodes 106 there between as shown in FIG. 1. The terminal electrode 110 is formed on both sides of the bare chip 102 in an embodiment. The terminal electrode 110 electrically contacts the internal electrodes 106.

The terminal electrode 110 is made of a conductive paste. The conductive paste is applied onto the bare chip 102. The conductive paste can be applied on both sides of the bare chip 102 in another embodiment. The conductive paste can be applied by screen printing, dipping or transfer printing in an embodiment.

The viscosity of the conductive paste is 1 to 500 Pa•s measured by Brookfield LVT or HBT with a spindle #14 at 10 rpm in an embodiment. The viscosity of the conductive paste can be 1 to 200 Pa•s in an embodiment, 10 to 100 in another embodiment, 1 to 60 in an embodiment, 10 to 40 Pa•s in another embodiment.

The applied conductive paste is heated at 250 to 400° C. and thereby the conductive paste is cured to become a terminal electrode 110. The heating temperature can be 260 to 360° C. in another embodiment, 280 to 320° C. in another embodiment. The heating time can be 10 to 120 minutes in an embodiment, 20 to 100 minutes in another embodiment, and 40 to 75 minutes in another embodiment. The heating temperature is adjustable in consideration of the heating time such as low temperature for long time and high temperature for short time.

The capacitor 100 is mounted on a circuit 12 formed on a substrate 10. In an embodiment, a solder paste is applied on the circuit 12 before mounting the capacitor 100.

The substrate 10 can be rigid or flexible. The substrate 10 can be a paper phenol substrate, a paper epoxy substrate, a glass epoxy substrate, a ceramic substrate, a Low temperature co-fired ceramic (LTCC) substrate, a polymer film, a glass substrate, a ceramic substrate or a combination thereof.

The circuit 12 is formed on the substrate 10. The circuit 12 is an electrical interconnection of electrical elements such as an electronic component, voltage sources, current sources and switches. The circuit 12 comprises metal such as copper, silver or gold in an embodiment.

The circuit 12 can be formed with a thick-film paste comprising an electrical conductive material in an embodiment. The thick-film paste can be screen printed on the substrate 10 in a desired pattern and cured by heat. A copper-clad laminate (CCL) that contains an insulating layer and a copper foil can be used to form the circuit 12 on the substrate 10 in another embodiment. A resist is placed over the copper foil and selectively removed. The remaining resist protects the copper foil. Subsequent etching removes the unwanted copper and the remaining copper foil is the desired circuit pattern.

The capacitor 100 and the circuit 12 are physically and electrically jointed with a solder 104. The solder 104 melts to flow into the joint between the terminal electrode 110 of the capacitor 100 and the circuit 12.

In one embodiment, the solder 104 comprise a metal selected from the group consisting of tin (Sn), lead (Pb), silver (Ag), copper (Cu), zinc (Zn), bismuth (Bi), indium (In), aluminum (Al) and combinations thereof.

The solder is lead-free in another embodiment. The lead-free solder comprise metals selected from the group consisting of tin (Sn), silver (Ag), copper (Cu), zinc (Zn), bismuth (Bi), indium (In), aluminum (Al) and combinations thereof. The lead-free solder can be selected from the group consisting of Sn/Ag/Cu, Sn/Zn/Bi, Sn/Cu, Sn/Ag/In/Bi or Sn/Zn/Al.

Lead-free solder is environment-friendly. However lead-free solder often provides less solderability and solder leach resistance than lead-containing solder. The electrical device of the present invention would result in fewer problems because the terminal electrode 110 of the electronic component has sufficient solderability and solder leach resistance against lead-free solder as well as lead-containing solder.

In an embodiment, a solder paste is used to joint the electronic component and the circuit. A solder paste is printed on the circuit and the electronic component is mounted on the printed solder paste followed by reflow process.

The solder paste is purchasable in the market, for example, Eco solder® from Senju Metal Industry Co., Ltd., Evasol® from Ishikawa Metal Co., LTD. and Fine solder® from Matsuo Handa CO., LTD. During the reflow, the substrate having the electronic component and the applied solder paste is subjected to controlled heat that melts the solder to connect the joint. The reflow temperature is 200 to 400° C. in an embodiment.

The terminal electrode 110 can be plated with a metal such as nickel and then soldered over the plating in another embodiment. The plating may further enhance the solderability and solder leach resistance of the terminal electrode 110. In another embodiment, the terminal electrode 110 can be directly soldered without plating.

The electronic component is a chip resistor in another embodiment. A chip resistor 200 comprises a bare chip 202 and a terminal electrode 210 as shown in FIG. 2. The bare chip 202 comprises an insulating ceramic layer 208, and internal electrodes 206 and a resistive layer 204 in an embodiment. The internal electrodes 206 are formed on the insulating ceramic layer 208 at both edges. The resistive layer 204 is formed on the ceramic substrate 208 to partially cover the internal electrodes 206. The terminal electrode 210 is formed on both sides of the bare chip 202. The terminal electrodes 210 contact the internal electrodes 206.

The resistor 200 is soldered to a circuit 12 formed on a substrate in a similar way to the capacitor described above in an embodiment.

The electronic component can be a resistor, a capacitor, an inductor or a semiconductor chip in an embodiment.

### Conductive Paste

The terminal electrode 110, 210 is made from a conductive paste. The following describes the conductive paste in detail.

The conductive paste comprises (i) 40 to 72 wt. % of a flaky silver powder, (ii) 3 to 30 wt. % of a copper oxide powder, (iii) 20 to 50 wt. % of an organic vehicle, wherein the wt. % is based on the weight of the conductive paste;

### (i) Silver Powder

The silver (Ag) powder is a metal powder with an electrical conductivity. in an embodiment the electrical conductivity of the Ag powder is 5.0×10⁷ S/m or more at 293 Kelvin. The Ag powder is flaky in shape. The particle diameter of the flaky Ag powder is 6 to 30 μm, 6.5 to 20 μm in another embodiment, 7.0 to 10 μm in still another embodiment. With these particle diameters, the terminal electrode will damage the solder less as shown in Example below. The particle diameter (D50) is obtained by measuring the distribution of the particle diameters using a laser diffraction scattering method and can be defined as D50. Microtrac model X-100 is an example of the commercially-available devices.

In an embodiment, the Ag powder has high purity for example, 97% or higher.

The Ag powder is 40 to 72 wt. %, 42 to 69 wt. % in another embodiment, and 45 to 65 wt. % in still another embodiment, based on the weight of the conductive paste.

### (ii) Copper Oxide Powder

The copper oxide powder is a powder of oxidized copper (Cu). The Cu oxide powder is copper(II) oxide (CuO), copper(I) oxide (Cu₂O) or a mixture thereof. A conductive paste containing the Cu oxide powder will result in less damage solder.

The particle diameter of the Cu oxide powder is 0.1 to 10 μm in an embodiment, 0.2 to 5 μm in another embodiment, and 0.3 to 3 μm in still another embodiment. The particle diameter (D50) is obtained as described above.

The Cu oxide powder is 3 to 30 wt. %, 5 to 28 wt. % in another embodiment, 4 to 15 wt. % in another embodiment, 5 to 10 wt. % in another embodiment, 11 to 27 wt. % in another embodiment, and 18 to 25 wt. % in still another embodiment, based on the weight of the conductive paste.

(iii) Organic Vehicle

The organic vehicle comprises an organic polymer and a solvent. The organic polymer is cured and the solvent evaporates during the heating step and thereby the organic polymer solidifies the Ag powder.

The organic vehicle is 20 to 50 wt. %, 24 to 45 wt. % in another embodiment, and 27 to 39 wt. % in still another embodiment, based on the weight of the conductive paste.

The organic polymer is 10 to 30 wt. % in an embodiment and 13 to 25 wt. % in another embodiment, based on the weight of the organic vehicle.

The organic polymer can be selected from the group consisting of phenoxy resin, melamine resin, phenolic resin, urea resin, epoxy resin, silicone resin, polyurethane resin, polyvinyl butyral resin, polyimide resin, polyamide resin, acrylic resin, ethyl cellulose, ethylhydroxyethyl cellulose, wood rosin, polyester resin, polyacetal resin and mixtures thereof.

The melting point of the organic polymer is 80 to 400° C. in an embodiment, 100 to 350° C. in another embodiment and 110 to 250° C. in still another embodiment.

The solvent can be used to adjust the viscosity of the conductive paste to be suitable for applying onto the bare chip. The solvent mostly or completely evaporates during the heating. The solvent can be selected from the group consisting of texanol, terpineol, carbitol acetate, ethylene glycol, ethylene glycol ethers, ethylene glycol ethers acetate, dibuthyl acetate, xylene, toluene, diethylene glycol ethers, diethylene glycol ethers acetate, propylene glycol ethers, dipropyleneglycol ethers and mixtures thereof .

The solvent is 65 to 85 wt. % in an embodiment and 72 to 82 wt. % in another embodiment, based on the weight of the organic vehicle.

The boiling point of the solvent can be 100 to 250° C. in an embodiment and 120 to 220° C. in another embodiment.

The organic vehicle further comprises an additive such as a surfactant, a dispersing agent, a stabilizer, a cross-linking agent and a plasticizer to provide a desired property of the conductive paste.

### EXAMPLES

The present invention is illustrated by, but is not limited to, the following

Examples.

The paste materials were:
Conductive powder: A flaky Ag powder of particle size (D50) of 8 μm or 5 μm.
Inorganic additive: A Cu₂O powder, a CuO powder, a CoO powder, a Fe₃O₄ powder or a Cu—Cr—Mn powder. Particle size (D50) was less than 1 μm.
Organic vehicle: A mixture of a phenoxy resin, a melamine resin and diethylene glycol butyl ether and dipropylene glycol methyl ether as a solvent.

The Ag powder, the inorganic additive and the organic vehicle were mixed well in a mixer followed by a three-roll mill. The amount of the each material in a conductive paste is shown in Table 1.

The conductive paste was applied onto a ceramic substrate. The ceramic substrate with the conductive paste was heated in a constant temperature oven at 300° C. for 60 minutes. The electrode was formed by the heating.

The electrode was further fired at 750° C. for 20 minutes in a furnace to completely remove the remaining organic vehicle from the electrode. The weight of the electrode after firing is shown in Table 1 below as a relative value to 100 of the electrode weight before firing.

There was little change in weight of the electrodes in Examples 1 to 4 in which the electrode contained copper oxide. On the contrary, the electrodes in Comparative Example 1 to 5 had weight loss larger than any of Examples 1 to 4.

The terminal electrode in Example 1 to 4 would hardly damage the solder at soldering temperatures by discharging the organic materials.

TABLE 1
(wt. %)

| | | Example | Example | Example | Example | Com. Ex. | Com. Ex. | Com. Ex. | Com. Ex. | Com. Ex. |
|---|---|---|---|---|---|---|---|---|---|---|
| | | 1 | 2 | 3 | 4 | 1 | 2 | 3 | 4 | 5 |
| Silver | Ag powder (D50 = 8 μm) | 62 | 55 | 48 | 48 | 48 | 48 | 49 | 69 | 0 |
| Powder | Ag powder (D50 = 5 μm) | 0 | 0 | 0 | 0 | 0 | 0 | 0 | 0 | 50 |
| Inorganic | Cu₂O powder | 7 | 14 | 21 | 0 | 0 | 0 | 0 | 0 | 21 |
| additive | CuO powder | 0 | 0 | 0 | 21 | 0 | 0 | 0 | 0 | 0 |
| | CoO powder | 0 | 0 | 0 | 0 | 21 | 0 | 0 | 0 | 0 |
| | Fe₃O₄ powder | 0 | 0 | 0 | 0 | 0 | 21 | 0 | 0 | 0 |
| | Cu—Cr—Mn powder | 0 | 0 | 0 | 0 | 0 | 0 | 21 | 0 | 0 |
| Organic | Phenoxy resin | 5.3 | 5.3 | 5.3 | 5.3 | 5.3 | 5.3 | 5.5 | 5.3 | 5.5 |
| vehicle | Melamine resin | 2 | 2 | 2 | 2 | 2 | 2 | 2 | 2 | 2 |
| | Solvent | 23.8 | 23.8 | 23.8 | 23.8 | 23.8 | 23.8 | 22.5 | 23.8 | 21.5 |
| | Weight after firing* | 99.9 | 99.6 | 99.4 | 100.1 | 94.0 | 95.2 | 93.7 | 94.5 | 94.8 |

*Relative value to 100 of the electrode weight before firing.

What is claimed is:

1. A method of manufacturing an electronic component comprising the steps of:
a) preparing a bare chip;
b) applying a conductive paste on the bare chip, wherein the conductive paste comprises,
(i) 40 to 72 weight percent (wt. %) of a flaky silver powder having particle diameter (D50) of 6 to 30 μm,
(ii) 3 to 30 wt. % of a copper oxide powder, and
(iii) 20 to 50 wt. % of an organic vehicle, wherein the wt. % is based on the weight of the conductive paste; and
c) heating the applied conductive paste at 250 to 400° C.

2. The method of claim 1, wherein the bare chip comprises at least one insulating ceramic layer and at least one internal electrode on the ceramic layer.

3. The method claim 1, wherein viscosity of the conductive paste is 1 to 500 Pa•s.

4. The method of claim 1, wherein the copper oxide powder is CuO, Cu₂O or a mixture thereof.

5. The method of claim 1, wherein the particle diameter (D50) of the copper oxide is 0.1 to 10 μm.

6. The method of claim 1, wherein the organic vehicle comprises an organic polymer selected from the group consisting of phenoxy resin, melamine resin, phenolic resin, urea resin, epoxy resin, silicone resin, polyurethane resin, polyvinyl butyral resin, polyimide resin, polyamide resin, acrylic resin, ethyl cellulose, ethylhydroxyethyl cellulose, wood rosin, polyester resin, polyacetal resin and mixtures thereof.

7. The method of claim 1, wherein the organic vehicle comprises an organic polymer having a melting point of 80 to 400° C.

8. The method of claim 1, wherein the organic vehicle comprises an organic solvent selected from the group consisting of texanol, terpineol, carbitol acetate, ethylene glycol, ethylene glycol ethers, ethylene glycol ethers acetate, dibuthyl acetate, xylene, toluene, diethylene glycol ethers, diethylene glycol ethers acetate, propylene glycol ethers, dipropyleneglycol ethers and mixtures thereof.

9. The method claim 1, wherein the heating time is 10 to 120 minutes.

10. The method claim 1, wherein the electronic component is a resistor, a capacitor, an inductor or a semiconductor chip.

11. A conductive paste for forming a terminal electrode of an electronic component comprising:
(i) 40 to 72 weight percent (wt. %) of a flaky silver powder having particle diameter (D50) of 6 to 30 μm,
(ii) 3 to 30 wt. % of a copper oxide powder, and
(iii) 20 to 50 wt. % of an organic vehicle,
wherein the wt. % is based on the weight of the conductive paste.

12. The conductive paste of claim 11, wherein viscosity of the conductive paste is 1 to 500 Pa•s.

13. The conductive paste of claim 11, wherein the copper oxide powder is CuO, Cu₂O or a mixture thereof.

14. The conductive paste of claim 11, wherein the particle diameter (D50) of the copper oxide is 0.1 to 10 μm.

15. The conductive paste of claim 11, wherein the organic vehicle comprises an organic polymer selected from the group consisting of phenoxy resin, melamine resin, phenolic resin, urea resin, epoxy resin, silicone resin, polyurethane resin, polyvinyl butyral resin, polyimide resin, polyamide resin, acrylic resin, ethyl cellulose, ethylhydroxyethyl cellulose, wood rosin, polyester resin, polyacetal resin and mixtures thereof.

16. The conductive paste of claim 11, wherein the organic vehicle comprises an organic polymer having a melting point of 80 to 400° C.

17. The conductive paste of claim 11, wherein the organic vehicle comprises an organic solvent selected from the group consisting of texanol, terpineol, carbitol acetate, ethylene glycol, ethylene glycol ethers, ethylene glycol ethers acetate, dibuthyl acetate, xylene, toluene, diethylene glycol ethers, diethylene glycol ethers acetate, propylene glycol ethers, dipropyleneglycol ethers and mixtures thereof.

18. The conductive paste of claim 11, wherein the heating time is 10 to 120 minutes.

19. The conductive paste of claim 11, wherein the electronic component is a resistor, a capacitor, an inductor or a semiconductor chip.
